(19) United States
(12) Patent Application Publication
(10) Pub. No.: US 2005/0046543 A1
(43) Pub. Date: Mar. 3, 2005

(54) Low-impedance electrical resistor and process for the manufacture of such resistor

(76) Inventor: Ullrich U. Hetzler, Dillenburg-Oberacheld (DE)

Correspondence Address: PATENT & TRADEMARK DOCKET CLERK;RYNDAK & SURI, 30 NORTH LASALLE STREET, SUITE 2630, CHICAGO, IL, 60602, US

(21) Appl. No.: 10/650,625

(22) Filed: Aug. 28, 2003

(51) Int. Cl. H01C 1/012

(52) U.S. Cl. 338/309

(57) ABSTRACT

In the manufacture of low-impedance electrical resistors made of a metal sheet or a film consisting of a metallic resistance alloy, a metal forming the connection contacts of the resistors is electroplated onto a multitude of photolithographically defined parallel strips, which extend, at regular mutual intervals, over the entire metal sheet or film surface. To separate the resistors, the electroplated metal piece is sawed longitudinally into cutting planes, which extend perpendicularly with respect to each other, and with respect to the metal sheet, where, in each case, the cutting planes of one group divide one of the connection contact strips in its longitudinal direction.

### DESCRIPTION OF THE BACKGROUND OF THE INVENTION

1. Field of the Invention

The invention relates to a low-impedance electrical resistor and a process for its manufacture according to the preamble of the independent claims. In particular, the resistors are low-impedance precision resistors for current measurement purposes of the SMD or chip construction type.

2. Background Art

In a process for the manufacture of SMD measurement resistors with resistance values in the milliohm range, a laminate is first formed from a copper metal sheet which serves as substrate and from a film consisting of a Cu-based resistor alloy and a heat-conducting adhesive located between them. On the free top side of the alloy film, connection contact areas for the individual resistors are then photolithographically defined, coated with copper by an electroplating process and covered with nickel. After the electroplating metallization, the structure itself of the resistors and their connection contacts is formed by etching. The resistor structure can have the usual four pole and/or meandering shape. The separation of the resistors can be carried out using a laser cutting installation or, preferably, by breaking the adhesive film, after the metal layers have been perforated on both sides by etching, along the provided separation lines. This known process is relatively expensive. Above all, it is hardly possible to produce resistors with precisely defined resistance values using the etching procedure which was required in the past. It is particularly difficult to structure by etching connection contacts which have been applied by electroplating onto the alloy film, without attacking the alloy metal located under it, and, moreover, the precision is negatively affected by the poorly defined shape of the front surfaces of the connection contacts, which is typical in etching, where the front surfaces are not precisely perpendicular to the surface, rather they run a more or less concave course up to the alloy surface.

In another process for the manufacture of SMD measurement resistors, connection contacts of a resistance films, which are bonded to a substrate and structured in the conventional manner are applied in the form of a paste in the screen printing procedure onto the film, optionally after a electroplating preliminary tin coating of the connection areas, and then remelted into compact “pearls.” Here too the desired precise resistance value can only be achieved by subsequent adjustment. The separation of these resistors in practice is carried out by stamping, the procedure which is also conventionally used for other similar known components.

### SUMMARY OF THE INVENTION

The invention is based on the problem of providing a process for the manufacture of precision resistors of the considered type, which is simpler than similar known processes and which, in particular, allows for the formation of the connection contacts without etching.

This problem is solved by the process for the manufacture of low-impedance electrical resistors, in which, onto photolithographically defined areas of a layer consisting of a metallic resistor alloy in the form of a metal sheet or a film, a metal is electroplated for the formation of connection contacts for a multitude of individual resistors, and the layer provided with the connection contacts is divided into the individual resistors, including the process steps of photolithographic formation of a cover mask, which is formed by a multitude of parallel strips extending over a surface of the layer, and at mutual identical intervals; electroplating of the layer on only its surface which carries the cover mask, for the deposition of the connection contact metal onto the resistor strip located between the parallel mask strips; and division of the electroplated layer along groups of cutting planes which are perpendicular with respect to the layer's surface and perpendicular with respect to each other, where the cutting planes which are parallel to the connection contact strips in each case divide one of the connection contact strips, while the other cutting planes separate the resistors at their edges which run transversely with respect to the connection contact strips as well as a resistor made by this process.

According to the invention it is possible, in a few simple work steps, to manufacture precision resistors in the milliohm range, which do not require subsequent adjustment, having resistance tolerances of at most ±5%. Neither the connection contacts nor the alloy areas have to be etched, and thus the drawbacks of structuring by the etching technology are avoided, namely the formation of running, nonperpendicular etching flanks, which lead to large variations in the resistance value and poor reproducibility.

One advantageous effect is that, according to the invention, after the photolithographic definition of the separation surfaces, the comparatively thick copper contact layers can be electroplated with high precision, where, in particular, the perpendicular formation, with respect to the main surface of the metal sheet or of a film forming the resistance layer, as well as the position of the flanks turned toward the activator resistor area are important.

The second prerequisite for the manufacture of precision resistors according to the invention is the obtention of a defined width. It is preferred to achieve this by sawing the electroplated resistance layer.

By means of sawing, a substantially higher precision and reproducibility of the resistors is achieved than with other separation processes such as etching, stamping and, for example, in the case of the use of lasers which itself is another possibility. In addition, it is possible to maximize the number of resistors, which can be manufactured for a given useful surface area by sawing.

The process is appropriate, among other purposes, for the manufacture of extremely low-impedance resistances, for example, in the range of approximately 0.5 mΩ to 5 mΩ in large scale manufacture, however, it is also possible to manufacture resistors with even lower or with higher resistance values, for example 0.01-50 mΩ. In a modified construction form with particularly thin resistor films, the resistance value can also be further increased without problem, for example, up to 100 mΩ. Moreover, the resistors are flexible and, depending on the desired load rating, they can be manufactured in sizes which can be as large or as small as desired. Since the resistor manufactured according to the invention substantially consists only of metal and since the organic adhesive used in the above-mentioned processes is either completely omitted or, if it is used at all, does not have to be heat conducting, it has the advantage of high heat resistance and high load capacity. In the application cases which are typical for this resistor it is sufficient to remove the dissipation heat amounts through the connection contacts, for example, into a circuit board on whose surface the resistors are mounted according to the SMD technique.

### BRIEF DESCRIPTION OF THE DRAWING FIGURES

The invention is further explained with reference to the embodiment examples represented in the drawing figures, which:

FIGS. 1(A) through 1(F) show the different successive steps or stages of the process according to the invention;

FIG. 2 is a perspective view of a resistor which has been manufactured according to the invention; and

FIG. 3 is a perspective view of a modified construction of another embodiment of the resistor according to the invention.

### DETAILED DESCRIPTION OF THE PREFERRED EMBODIMENTS

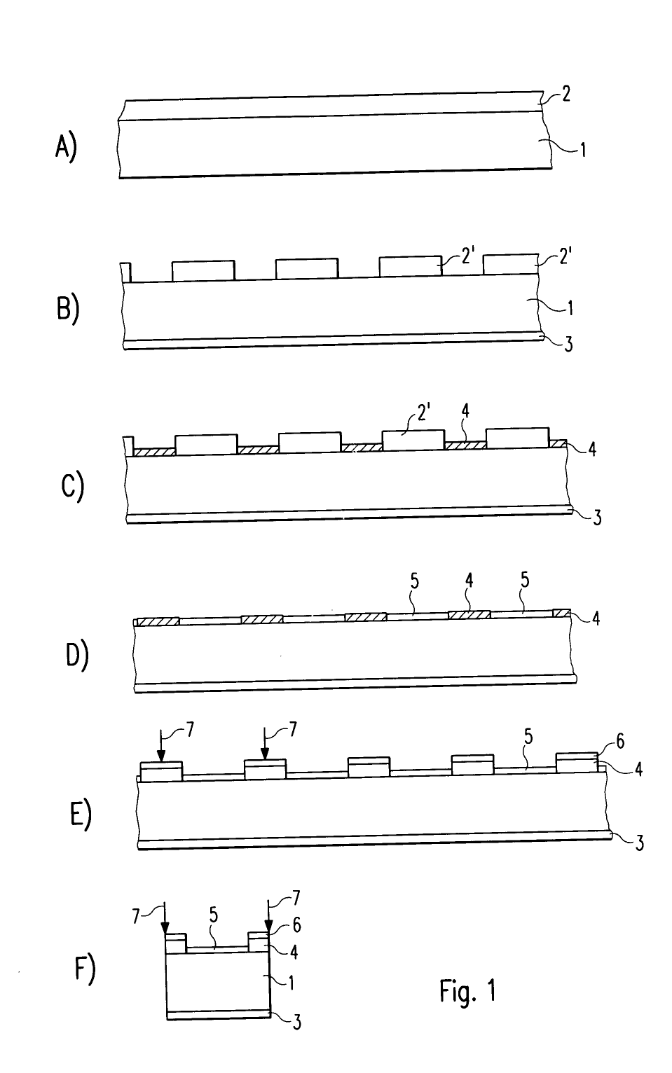

According to FIG. 1A), in the first process step, a blank rectangular metal sheet 1 consisting of a metallic resistor alloy is coated with a photoresist layer 2 which can be illuminated, in the manner conventionally used in photolithography, through a photomask (not shown). The metal sheet 1, in practical cases, can have a useful surface area of, for example, approximately 300×400 mm, and a thickness between 0.1 and 1 mm. It is preferably made of one of the proven resistor alloys based on Cu such as CuMn₁₂Ni or a similar material.

In the next step, according to FIG. 1B), again in a manner which in itself is known, the photolithographic structure of the photoresist layer 2 is formed by partial removal. This structure, which serves as cover mask, consists of a multitude of parallel strips 2′ which extend over the entire width or length of the top surface (in the drawing) of the metal sheet 1, or at least of the surface area to be used; as a rule, the strips have the same width and they are at the same mutual intervals which remain the same over the entire strip length.

Before, after, or simultaneously with the photolithographic structuring of the photoresistance layer 2, the bottom side of the metal sheet 1 is covered with a protective film 3, which prevents a metallization of the metal sheet bottom side during the subsequent electroplating.

FIG. 1C) shows the process stage after the electroplating deposition of copper onto the metal sheet strip which has been left free between the strips 2′ of the cover mask. The copper strips 4, which have been deposited by separation, consequently extend, again with the same width and at the same mutual intervals which remain the same over the entire strip lengths, over the entire width or length of the useful surface of the metal sheet 1.

In the process stage according to FIG. 1D), the photoresist strips 2 are removed and replaced by a protective lacquer. The protective lacquer strips 5 can be applied, for example, manually with a spatula or a doctor knife. They prevent a metallization of the areas located between the copper strips 4 of the metal sheet 1 during a subsequent electroplating reinforcement of the copper strips and, moreover, they later also protect, like the protective film 3, the surface of the alloy area of the finished resistor.

According to FIG. 1E), additional copper can be applied by electroplating onto the copper strips 4 to reinforce the contacts and/or an additional metal can be electroplated. By means of a tin layer 6 on the copper surface, the latter is protected from running and the later soldering of the resistor to a circuit plate or similar part is facilitated. The strips 4 with a tin layer 6 form the connection contacts of the individual resistors to be produced.

Now the precision resistors which are already finished can be separated. For this purpose, the metal sheet 1 which is provided with the connection contacts is separated along groups of cutting planes which are perpendicular to the metal sheet surface and perpendicular to each other. The cutting planes of one of these two groups run parallel to the copper strips 4 and thus to one of the edges of the metal sheet 1 through the entire metal sheet and, in each case, they are located in the middle of one of the copper strips 4, which as a result are divided in each case into two identical strip parts, along the arrows 7 in FIG. 1E) and in FIG. 1F). In FIG. 1F), as the last or next to last process stage, the separated resistor or a strip which still remains to be divided along the second group of cutting planes, is represented. The cutting planes of the second group run parallel to the other metal sheet edge, again through the entire metal sheet along the lateral edges of the individual resistors.

This separation of the resistors is best carried out by sawing the individual cutting planes. Sawing presents the advantage of allowing a very precise maintenance of the desired dimensions of the resistors in each case with planar cutting surfaces which are precisely perpendicular to the metal sheet plane. Precision sawing machines which are suitable for this purpose, which can be oriented (referenced) for example optically, with the electroplated metal sheet, and which operate with high precision in the μm range, in themselves are known and available commercially. For the sawing, the metal sheet is advantageously bonded to a support, and later it is then unproblematic to separate the separated resistors from its adhesive layer. It is advantageous for the electroplated metal sheet to be first sawed along one of the two groups of cutting planes into individual strips, which in turn can then be sawed to form the individual resistors. Depending on the type of sawing machine, it is theoretically also possible to simultaneously saw off or saw apart several strips. From a metal sheet having the purpose mentioned above as an example and dimensions of approximately 300×400 mm, it is possible to cut by sawing more than 10,000 resistors in the manner as has been described here.

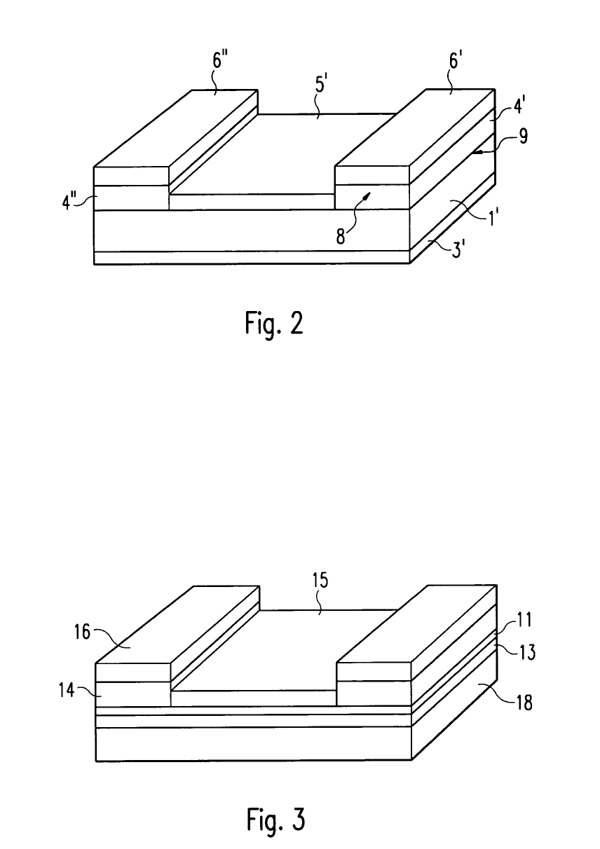

The individual resistor which is formed after the last process step is represented schematically (not to scale) in FIG. 2. The finished resistor consists of the rectangular alloy metal sheet 1′, on whose opposite ends the rectangular connection contacts 4′ and 4″ with the tin layers 6′, 6″ are applied by electroplating. The connection contacts which are formed by the electroplating deposition of copper, optionally in several layers, are advantageously relatively thick, to achieve a good input and output of the current into or out of the alloy, respectively, among other purposes. For example, the thickness of the copper can be approximately 50-100 μm.

As can be seen, the resistor, at the mentioned opposite ends, presents planar front surfaces 9 of the connection contacts and of the metal sheet piece 1′ itself, which are aligned precisely perpendicularly to the metal sheet plane. The same applies to the two lateral front surfaces 8 of the connection contacts and the metal sheet piece 1′. The protective lacquer layer 5′ is located between the connection contacts, while the surface of the resistor which is turned away from the contacts may still be covered by the protective film 3′.

The modified resistor represented in FIG. 3 differs from the construction variant according to FIG. 2 only in that, instead of the relatively thick metal sheet piece 1′, which is covered with the protective film 3′, a substantially thinner resistor film 11 was used, which is attached to a double-sided adhesive film 13 used as a protective film. The resistor film 11, whose thickness is less than 100 μm, for example, as low as 20 μm, has been fixed for the purpose of ease of handling, that is for mechanical stabilization, by means of the protective and adhesive film 13 to a substrate 18, which can be, for example, a 0.5 mm thick aluminum sheet.

The connection contacts 14 with the tin layers 16 and the protective lacquer layer 15 correspond to the embodiment according to FIG. 2, and the manufacture of the modified resistor is also carried out substantially according to the process described with reference to FIG. 1 with the condition that, in the step according to FIG. 1A), instead of the relatively thick metal sheet 1, the laminate is used, which consists of the thin resistor film 11, the double-sided adhesive film 13 and the substrate 18, where the adhesive film 13 and the substrate 18 can replace the protective film 3. The resistance values which have been achieved by this manufacture can typically be on the order of magnitude of 50 or also 100 mΩ.

Instead of the bonded aluminum substrate 18, the ease of handling an optionally very thin resistor film, such as the film 11 in FIG. 3, can also be achieved by means of a nonmetallic substrate which is suitable for the mechanical stabilization of the film, so that a resistor is produced which corresponds to the embodiment example of FIG. 2 except that a thinner film piece was used instead of the metal sheet piece 1′ and a thicker nonmetallic substrate was used instead of the protective film 3′ (or to the embodiment example according to FIG. 3, in which the adhesive film 13 and the substrate 18 are replaced by a single substrate layer, onto which the resistor film 11 can be bonded).

1. A low-impedance electrical resistor, comprising
a flat rectangular metal piece made of a resistor alloy;
and connection contacts applied by electroplating on a main surface of the metal piece on opposite ends thereof,
wherein the front surfaces of the metal piece and the connection contacts at said ends and the side surfaces of the metal piece and the connection contacts which abut perpendicularly against these front surfaces in each case are aligned with each other perpendicularly to the plane of the main surface of the metal piece.

2. The low-impedance electrical resistor according to claim 1, wherein the resistance value of the resistor is between approximately 0.5 mΩ and approximately 5.0 mΩ.

3. The low-impedance electrical resistor according to claim 1, wherein the metal piece is a film which is attached to a substrate by its side which is turned away from the connection contacts.

4. The low-impedance electrical resistor according to claim 3, wherein the film has a thickness of less than 100 μm.

5. The low-impedance electrical resistor according to claim 3, wherein the resistance value of the resistor is greater than 10 mΩ and preferably greater than 50 mΩ.

6. A process for the manufacture of low-impedance electrical resistors, in which, onto photolithographically defined areas of a layer consisting of a metallic resistor alloy in the form of a metal sheet or a film, a metal is electroplated for the formation of connection contacts for a multitude of individual resistors, and the layer provided with the connection contacts is divided into the individual resistors, characterized by the process steps of:
a) photolithographic formation of a cover mask, which is formed by a multitude of parallel strips extending uniformly spaced from each other over a surface of the layer;
b) electroplating of the layer on only its surface which carries the cover mask, for the deposition of the connection contact metal onto the resistor strip located between the parallel mask strips; and
c) division of the electroplated layer along groups of cutting planes which are perpendicular with respect to the layer's surface and perpendicular with respect to each other, where the cutting planes which are parallel to the connection contact strips in each case divide one of the connection contact strips, while the other cutting planes separate the resistors at their edges which run transversely with respect to the connection contact strips.

7. The process for the manufacture of low-impedance electrical resistors according to claim 6, wherein the electroplated layer is sawed for the separation of the resistors.

8. The process for the manufacture of low-impedance electrical resistors according to claim 6, wherein, prior to the electroplating, the back side of the layer is covered with a protective film.

9. The process for the manufacture of low-impedance electrical resistors according to claim 6, wherein, after the separation of the connection contact metal, the mask strips are removed and replaced by a protective lacquer is applied onto the layer.

10. The process for the manufacture of low-impedance electrical resistors according to claim 6, wherein prior to the separation step of the resistors, at least one additional layer made of the same metal or of another metal is applied onto the connection contact strips by electroplating.

11. The process for the manufacture of low-impedance electrical resistors according to claim 6, wherein a metal sheet or a film made of a Cu alloy is coated with copper for the formation of the connection contact strips and the copper strips are tin coated.

12. The process for the manufacture of low-impedance electrical resistors according to claim 6, wherein the length, width and thickness of the metal sheet pieces which remain after the separation of the resistors and the mutual interval of the remaining connection contacts are chosen to have dimensions for resistance values between approximately 0.1 mΩ and approximately 5 mΩ.

13. The process for the manufacture of low-impedance electrical resistors according to claim 6, wherein the cover mask is produced on a film consisting of the resistance alloy and having a thickness of less than 100 μm, whose handling ease is achieved by attachment on a substrate, and in that the length, width and thickness of the film pieces which remain after the separation of the resistors are chosen with dimensions for resistance values of more than 10 mΩ and preferably more than 50 mΩ.

14. The low-impedance electrical resistor according to claim 1, wherein the resistor further comprises front and side surfaces cut by sawing.

15. The low-impedance electrical resistor according to claim 1, wherein the resistor further comprises front and side surfaces cut by a laser.
